(19) United States
(12) Patent Application Publication
(10) Pub. No.: US 2014/0067816 A1
(43) Pub. Date: Mar. 6, 2014

(54) SURFACING ENTITY ATTRIBUTES WITH SEARCH RESULTS

(71) Applicants: Tapas Kanungo, Redmond, WA (US); Ashok Ponnuswami, Kirkland, WA (US)

(72) Inventors: Tapas Kanungo, Redmond, WA (US); Ashok Ponnuswami, Kirkland, WA (US)

(73) Assignee: MICROSOFT CORPORATION, Redmond, WA (US)

(21) Appl. No.: 13/597,596

(22) Filed: Aug. 29, 2012

(51) Int. Cl. G06F 17/30

(52) U.S. Cl. 707/740; 707/769; 707/737; 707/E17.014; 707/E17.089

(57) ABSTRACT

In an effort to enhance computer user engagement with a search results page, systems and methods are presented which are configured to identify an entity as being the subject matter of a user's search query. If the entity is a known entity, i.e., entity information is stored in an entity store for the identified entity, a subset of entity attributes are identified and a representative entity attribute question is obtained for each of the attributes in the subset of entity attributes. The representative entity attribute questions are identified according to the probability that they are formed linguistically correct. The representative entity attribute questions are included in a search results page that is generated in response to the user's search query.

### BACKGROUND

A typical search engine receives a search query from a user and, in response, provides search results relevant to the topic of the search query. Largely, the search results are references, or hyperlinks, to documents and/or content stored at other internet locations. To be able to provide search results in this manner, a typical search engine will maintain a content store from which the search engine draws the various references/hyperlinks in response to a search query. Indeed, search engines have massive amounts of information. However, search engines can also store information beyond references or hyperlinks. It would be advantageous for a user to be able to submit a query for and receive specific information, not just a reference to the specific information.

Generally speaking, search engines operate as “free” services, i.e., the computer user that submits a query does not incur a monetary charge for the results. To maintain the “free” service, a search engine will sell advertising on the search results page (which is generated in response to a user's search query). The more time that a computer user spends on a search results page and the more times that a user views a search results page, the better able the search engine operator is to monetize the user's “visit.” In other words, a search engine is advantaged when the search engine is able to keep the user engaged with the search results page for as long as possible.

### SUMMARY

According to aspects of the disclosed subject matter, a computer-implemented method for responding to a search query from a user is presented. As implemented on a computing system comprising at least a processor and a memory, the method comprises obtaining a plurality of search results responsive to a search query received from a computer user. At least one search results page is generated that includes a portion of the obtained search results. In addition to the obtained search results, the at least one generated search results page includes a plurality of entity attribute questions. The entity attribute questions are questions that correspond to attributes related to the entity that is identified as the subject matter of the search query.

According to additional aspects of the disclosed subject matter, a computer-readable medium bearing computer-executable instructions is presented. The instructions, when executed by a processor, carry out a method for responding to a search query from a user. The method comprises obtaining search results responsive to a search query received from a computer user. At least one search results page is generated that includes a portion of the obtained search results. In addition to the obtained search results, the at least one generated search results page includes a plurality of entity attribute questions. The entity attribute questions are questions that correspond to attributes related to an entity that is identified as the subject matter of the search query.

According to yet additional aspects of the disclosed subject matter, a computer system configured to respond to search queries is presented. The computer system includes a processor and a memory, the memory storing executable instructions. The computer system further includes a search results component that responds to a search query received from a user by obtaining search results responsive to the search query. Also included is a search results page generator that generates at least one search results page based on at least a portion of the obtained search results. The at least one search results page also includes entity attribute questions. Entity attribute questions are questions relating to an attribute of an entity that is identified as the subject matter of the received search query.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a diagram illustrating an exemplary networked environment suitable for implementing aspects of the disclosed subject matter;

FIGS. 2A-2C are pictorial diagrams of an exemplary browser view showing an illustrative embodiment of a search results page into which entity attribute questions have been incorporated;

FIG. 3 is a flow diagram of an illustrative routine for responding to a search query in accordance with aspects of the disclosed subject matter;

FIG. 4 is a flow diagram of an illustrative routine for clustering search queries and other data to correspond to entity attributes;

FIG. 5 is a flow diagram of an illustrative routine for selecting a linguistically correct representative entity attribute question from a cluster of data associated with an entity attribute for a particular entity; and

FIG. 6 shows illustrative components of a search engine configured to respond to a computer user's search query with search results and with entity attribute questions corresponding to attributes of unknown entity.

### DETAILED DESCRIPTION

For purposed of clarity, the use of the term “exemplary” in this document should be interpreted as serving as an illustration or example of something, and it should not be interpreted as an ideal and/or leading illustration of that thing. The term “entity” refers to (by way of illustration and not limitation) a concept, a person, an organization, or a thing. A user will submit a search query including one or more query terms, and these query terms relate to one or more entities—i.e., the intent of the search query. For example, a search query for the “governor of the state of Washington” is an entity and refers to different people (who may also be entities) depending on the time frame. Similarly, a search query, “Paris, France”, relates to an entity, i.e., the capital city in France. Search queries may specify multiple entities. For example, the search query “Paris France Eiffel Tower” may refer to two entities: (1) the capital of France and (2) the “Eiffel Tower.” The search query “Washington state senators” refers to multiple entities: the two current senators or, alternatively, those people who have served as a senator for the state of Washington.

By including entity attribute questions directed to attributes of the subject matter of a user's search query along with the typical search results, where the questions touch on interesting and relevant aspects of the subject matter (the entity) of the search query, the user is more likely to remain engaged for a longer period of time with the search results page. According to aspects of the disclosed subject matter, a search engine is configured to determine that a user's search query is directed to an entity and, upon detecting so, provides both search results as well as entity attribute question to the user in a search results page.

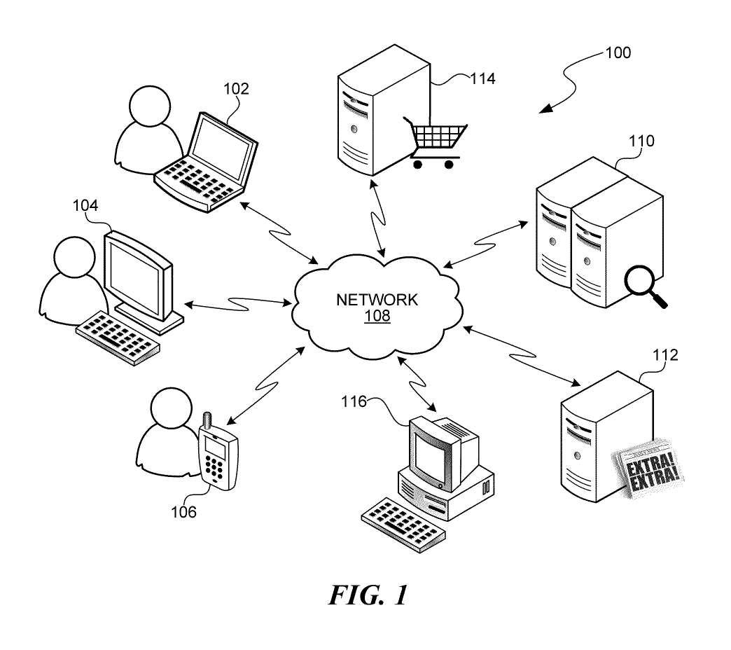

Turning to FIG. 1, this figure shows is a diagram illustrating an exemplary networked environment 100 suitable for implementing aspects of the disclosed subject matter. The illustrative environment 100 includes one or more user computers, such as user computers 102-106, connected to a network 108, such as the Internet, a wide area network or WAN, and the like. Also connected to the network 108 is a search engine 110 configured to provide search results and entity attribute questions in response to a search query from a computer user.

Those skilled in the art will appreciate that, generally speaking, a search engine 110 corresponds to an online service hosted on one or more computers, or computing systems, located and/or distributed throughout the network 108. The search engine 110 receives and responds to search queries submitted over the network 108 from various computer users, such as the users connected to user computers 102-106. In particular, responsive to receiving a search query from a computer user, the search engine 110 obtains search results information related and/or relevant to the received search query (as defined by the terms of search query.) The search results information includes search results, i.e., references (typically in the form of hyperlinks) to relevant and/or related content available from various target sites (such as target sites 112-116) on the network 108.

The search results information may also include other information such as related and/or recommended alternative search queries, data and facts regarding the subject matter of the search query, products and/or services related/relevant to the search query, advertisements, and the like. According to various embodiments of the disclosed subject matter, the search engine 110 further determines whether the user's search query relates to an entity that is known to the search engine. For purposes of this disclosure, an entity is “known” to the search engine 110 when there is entity information relating to the entity that is stored by the search engine. According to various embodiments, this entity information is stored in an entity store. The entity information includes a plurality of entity attributes relating to the entity, some of which may be associated with particular attribute values. As will be discussed below, entity attribute questions (questions corresponding to an attribute of an entity) are included with the search results. The entity attribute questions engage the user since the entity attribute questions are selected as being the most important or relevant or popular aspects of a given entity to surface to the user.

According to various embodiments, entity identification from the subject matter of a search query, as well as entity attribute question selection, is performed by an entity component within a suitably configured search engine 110. While not shown, in an alternative embodiment an entity component may be implemented as a separate, cooperative process/service to the services offered by a typical search engine. In a further alternative embodiment (also not shown), an entity component may be implemented as a stand-alone service on the network 108 for use by users and or other services. Accordingly, while the entity component is generally discussed in this document as being included as part of the search engine 110 in FIG. 1, it should be appreciated that the system 100 of FIG. 1 is illustrative only and should not be construed as limiting upon the disclosed subject matter.

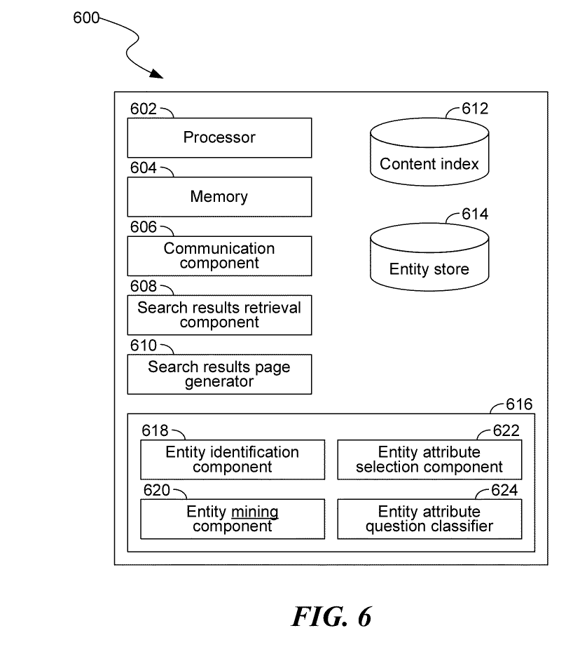

As those skilled in the art will appreciate, target sites, such as target sites 112-116, host content that is available and/or accessible to users (via user computers) over the network 108. The search engine 110 will be aware of at least some of the content hosted on the many target sites located throughout the network 108, and will store information regarding the hosted content of the target sites in a content index (612 of FIG. 6). The search engine 110 draws from the content index when obtaining search results information in response to receiving a search query. As shown in FIG. 1, the target sites include, by way of illustration and not limitation, a news organization 112, an online shopping site 114, and a self-published author's site 116. Of course, those skilled in the art will appreciate that any number and type of target sites may be connected to the network 108. Moreover, as is known in the art, some search engines are aware of millions of target sites and the content that is hosted by those target sites.

Suitable user computers for operating within the illustrative environment 100 include any number of computing devices that can communicate with the search engine 110 or target sites 112-116 over the network 108. In regard to the search engine 110, communication between the user computers 102-106 and the search engine 110 include both submitting search queries and receiving responses in the form of corresponding search results pages from the search engine 110, as discussed above. User computers 102-106 may communicate with the network 108 via wired or wireless communication connections in the user computers 102-106. These user computers 102-106 may comprise, but are not limited to: laptop computers such as user computer 102; desktop computers such as user computer 104; mobile devices such as user mobile device 106; tablet computers (not shown); on-board computing systems such as those found in vehicles (not shown); mini- and/or main-frame computers (not shown); and the like.

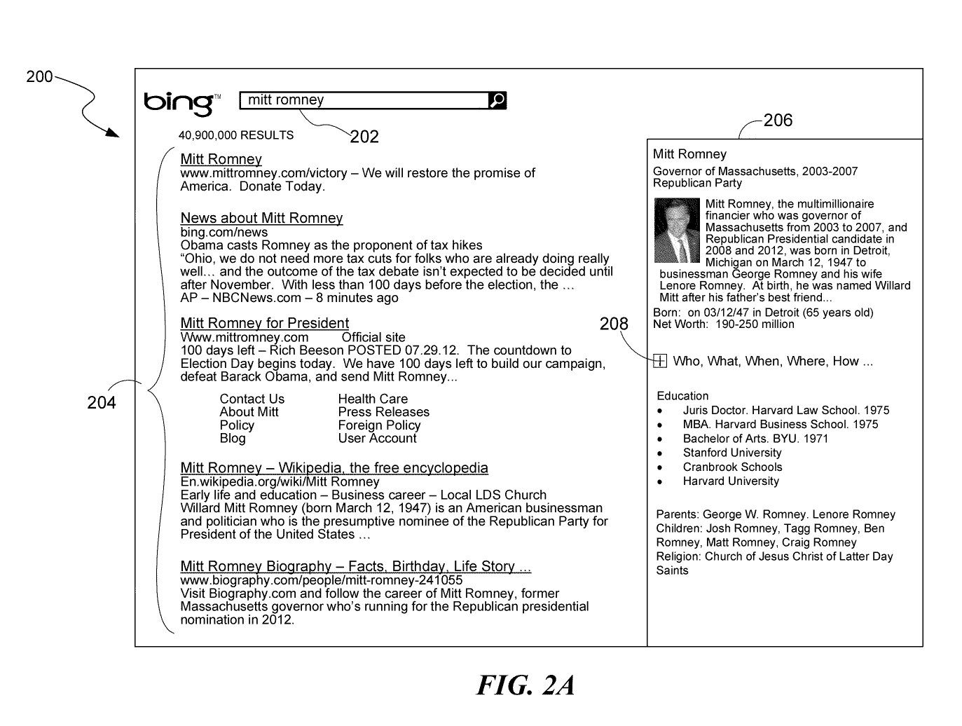

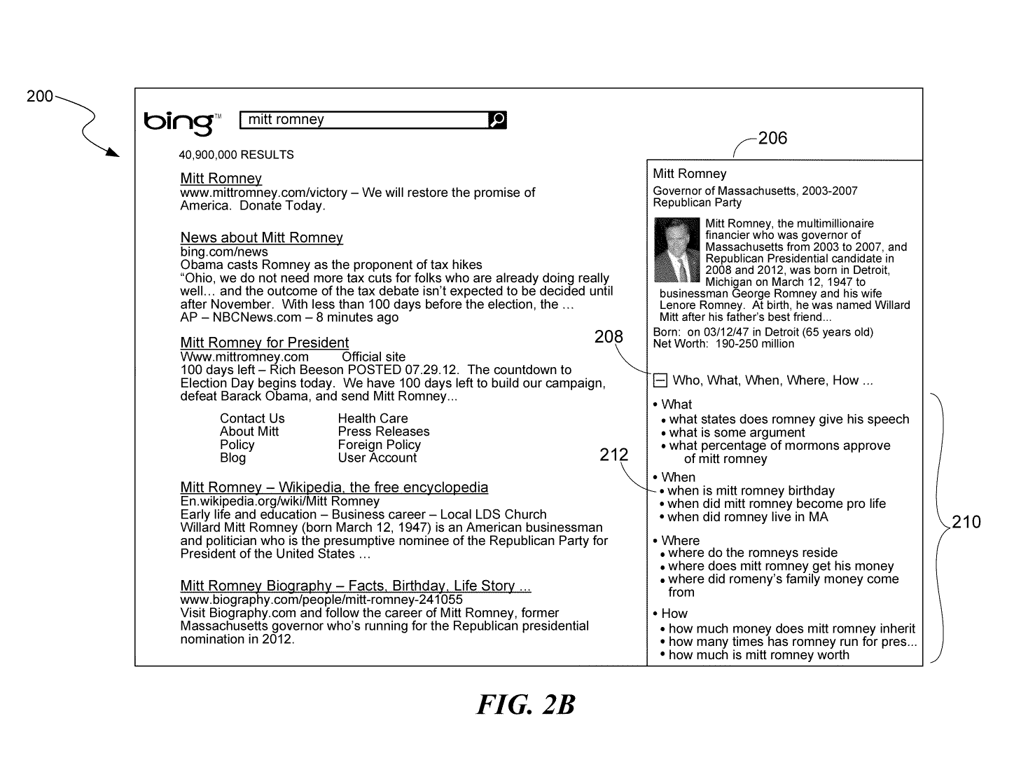

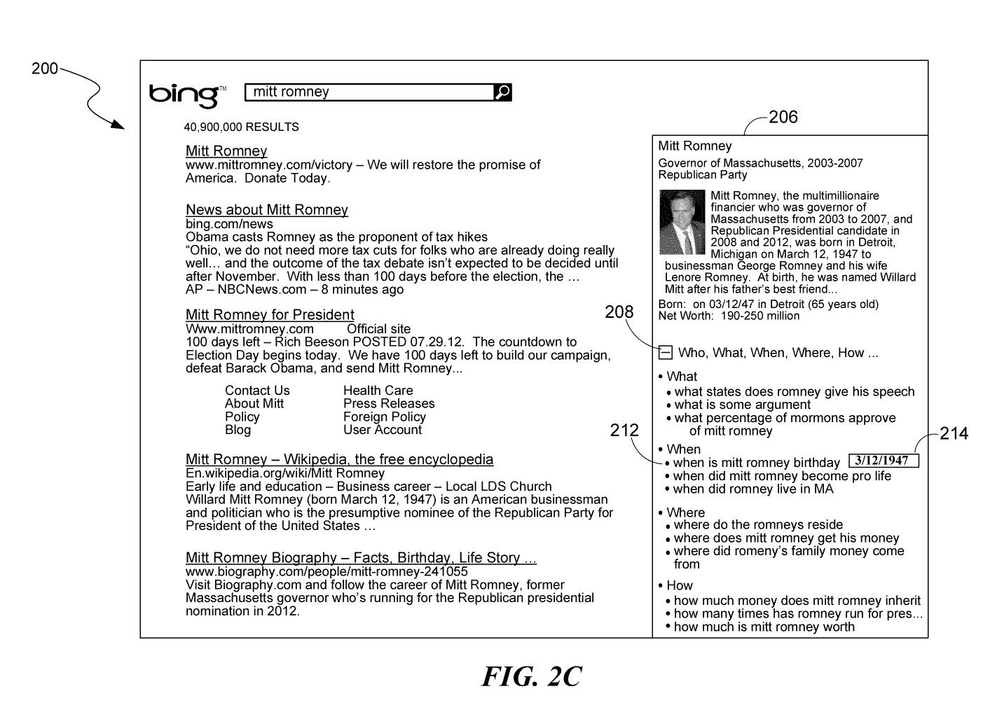

Turning now to FIG. 2A-C, these figures show an illustrative embodiment of a search results page 200 into which entity attribute questions have been incorporated. As shown in FIG. 2A, the search results page 200 includes search results 204 retrieved from a content index in response to the search query 202, “mitt romney.” Also included in the search results page 200 is an entity pane 206 that includes information specific to the entity (in this case, Mitt Romney) that was determined by an entity component to be the subject matter of the search query 202. According to at least one embodiment, an entity pane 206 is generated when the entity identified from the search query is a known entity to the search engine 110. When the entity is a known entity, the search engine can provide specific information (such as the entity pane 206) to the user regarding the identified, known entity. Included in the entity pane 206 is an actionable control 208 by which the computer user reveal entity attribute questions relating to specific attributes of the known entity. In this illustrative embodiment, activating the actionable control 208 causes the entity attribute questions 210 to be displayed, as shown in FIG. 2B.

As shown in FIG. 2B and according to at least one embodiment of the disclosed subject matter, the entity attribute questions 210 are grouped or categorized together according to the nature of the question, i.e., “what,” “when,” “where,” “why,”, “who,” and “how.” The particular groupings of entity attribute questions 210, (based on “what,” “when,” “where,” and “how”) should be viewed as illustrative and not viewed as limiting to the types/nature of groupings of questions that can be presented.

Each of the entity attribute questions 210 relate to a specific entity attribute of the known entity. For each entity there is a plurality of entity attributes associated with the entity. According to aspects of the disclosed subject matter, entity attributes that are deemed most important (and, therefore, potentially most likely to keep the user engaged with the current search results page) are selected for surfacing/presentation to the computer user. The entity component determines which are the “important” entity attributes, which are presented or surfaced to the user in the form of the entity attribute questions 210, according to any number of criteria including (by way of illustration and not limitation): the popularity of the entity attribute as determined by the number of queries for the information; whether the attribute is a trending topic with the search engine or a social network; whether the entity attribute is unusual and/or distinctive to this entity or otherwise considered important; importance of the entity attribute based on the time of year or some other periodic occurrence, and the like. In at least one embodiment, the “important” entity attributes are determined for each entity.

According to additional aspects of the disclosed subject matter, each or any of the entity attribute questions 210 may be included in the search results page 200 as actionable controls, such as hyperlinks. For example, with reference to entity attribute question 212 of FIG. 2C, when selected or otherwise activated, the actionable portion of entity attribute question 212 causes a corresponding entity attribute answer 214 to be displayed. Alternatively (not shown), when selecting an entity attribute question, a pop up window may be presented showing the answer of the entity attribute question. In another alternative embodiment (not shown), the user is hyperlinked to content that displays the answer to the entity attribute question.

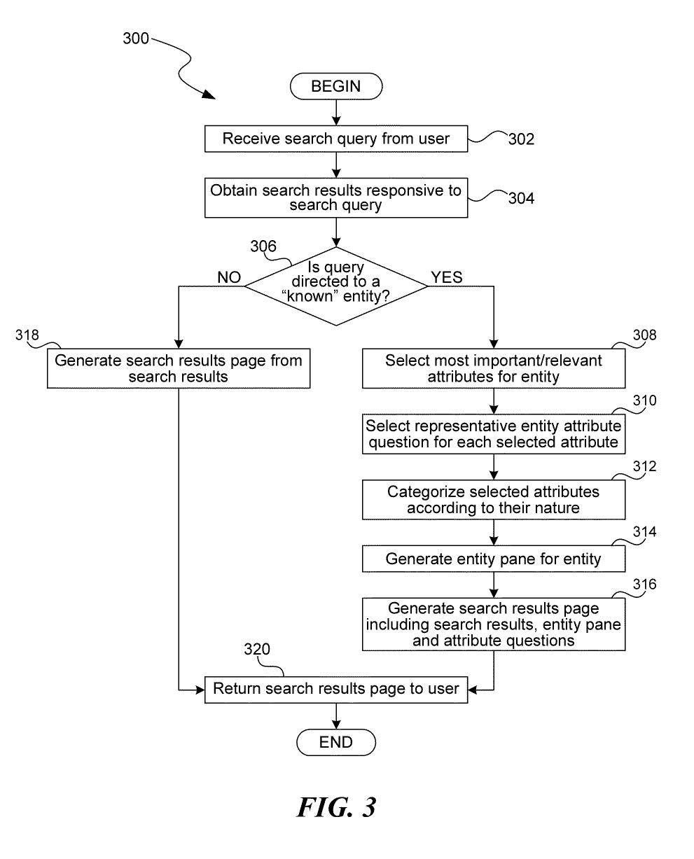

Turning now to FIG. 3, FIG. 3 is a flow diagram of an illustrative routine 300 for responding to a search query from a computer user in accordance with aspects of the disclosed subject matter. Beginning at block 302, a search query is received from a computer user. At block 304, search results responsive to the user's search query are obtained. As discussed, these search results are obtained from a content index maintained by the search engine 110. At decision block 306, a determination is made as to whether the user's search query is directed to a known entity. As discussed above, a “known entity” is an entity that an entity component (or search engine 110) recognizes and for which the entity component has access to corresponding entity information, including a plurality of entity attributes of the identified entity.

If at decision block 306 the query is not directed to a known entity, the routine 300 proceeds to block 318. At block 318, a search results page is generated based, at least in part, on the obtained search results. At block 320, the search results page is returned to the computer user in response to the user's search query. Thereafter, the routine 300 terminates.

Alternatively, returning to decision block 306, if the user's search query is directed to a known entity, the routine proceeds to block 308. At block 308, the most important entity attributes associated with the entity are selected. As previously mentioned, the most interesting or important or relevant attributes is based on a variety of criteria including query popularity of the particular entity attribute, whether the entity attribute is the subject matter of a trend, whether there is a periodic correlation between the entity attribute and the present conditions or events, unusual and/or distinctive attributes of the entity, and general category priorities of a particular entity type (such as an entity of the type “politician;” an important entity attribute might be “party association”).

The “important” entity attributes may be based on importance/relevance/current interest of the attribute to, by way of illustration and not limitation: a general population, a specific person (i.e., personalize to a particular person), a person's social network, or any combination of these. By way of example, common queries in regard to the actor, Tom Cruise, may be directed to the actor's height (generally speaking, he is not very tall). On the other hand, common queries in regard to the actor, Tom Hanks, are not generally directed to his height. Hence, an “important” attribute for Tom Cruise may include his height while an “important” attribute for Tom Hanks would not. On the other hand, for a particular user that often checks the height of actors, the height of Tom Hanks may be surfaced as an important attribute based on personalization to the specific user's interests. Still further, unusual attributes may be surfaced, not because they are common, but unusual. For example, while perhaps the height of the actor Michael J. Fox is not a common query or an attribute that would be surfaced due to personalization, the fact that he was not very tall may be surfaced as an interesting attribute because it falls outside of what is viewed as usual.

According to at least one embodiment of the disclosed subject matter, the important attributes are determined on a per entity basis. In an alternative embodiment, the important attributes are determined according to a per entity basis in conjunction with a per category basis. The “category basis” of an entity attribute corresponds to the type of entity. By way of illustration and not limitation, as mentioned above, an entity of the type “politician” will likely have an attribute of “party association.” Similarly, religious leaders may have a category based attribute of “religious order” and which may be considered highly relevant and important on a category basis. On the other hand, not all attributes associated with all entities of a particular category will always be important or relevant. For example (by way of illustration only), the “politician” category of entities may have an attribute of “home state” but that attribute may or may not be relevant or interesting for a given politician/entity.

At block 310, a representative entity attribute question is selected for each corresponding selected entity attribute. As will be appreciated by those skilled in the art, as the entity attributes are selected according to their importance, relevance, and/or current interest (both to a large population and specifically to the individual), the representative entity attribute questions may be viewed as a list of frequently asked questions (FAQs). According to various embodiments of the disclosed subject matter, the representative entity attribute question is selected according to the probability that the question is formed linguistically correct. To better understand the purpose of selecting a representative entity attribute question, especially one that is formed linguistically correct, a discussion is in order with regard to the source of the entity attributes.

As already discussed, in order to determine what is important/relevant/interesting about a particular entity, a variety of criteria are evaluated, including but not limited to: the number of queries directed to a particular attribute for an entity; whether that particular attribute corresponding to an entity is a trending topic; whether the attribute is unusual and/or distinctive; user preferences; as well as other criteria. All of these suggest that the entity component (or search engine 110) analyze and mine various data sources. As to the data sources, these include (by way of illustration only): search queries; available content on the network 108; subjects and topics discussed among social networks; news articles; and the like. By evaluating these and other data sources, the search engine 110 and/or an entity component identifies entity attributes and related attribute values associated with numerous entities. These attribute/attribute value pairs are then stored in association with the entity in an entity store. In at least one embodiment, the search engine 110 (or the entity component) continually mines the various data sources to maintain the freshness and relevancy of the information in the entity store, particularly the attribute/attribute value pairs, for the entities in the entity store. Additionally, the various data sources or signals upon which important attributes are selected for surfacing to a user can be combined and/or utilized using automated machine learning techniques and algorithms to optimize various metrics such as, by way of illustration and not limitation: the number of distinct queries to be presented, the number of follow up queries that are answered, human judgment factors, and the like. Moreover, various combinations can also be implemented in an ad hoc way as a quick implementation.

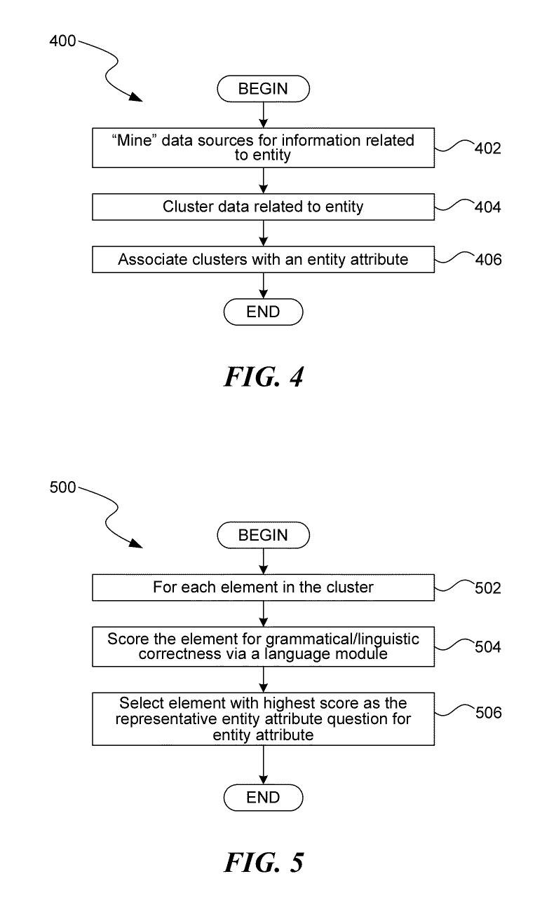

As those skilled in the art will appreciate, search queries as well as other data sources represent a large volume of information which must be broken down according to entities, entity attributes and (sometimes) attribute values. FIG. 4 is a flow diagram of an illustrative routine 400 for clustering search queries and other data corresponding to an entity. Beginning at block 402, the various data sources are mine for information related to a particular entity. At block 404, the data identified as being associated with the entity is then clustered. The result of the clustering is that the elements (e.g., search queries, content, and other data) within each cluster are highly related to each other, and elements of different clusters have little to no relationship. Clustering data such as search queries and content is a known discipline in any number of clustering techniques may suitably be employed.

At block 406, each cluster is then associated with an entity attribute corresponding to the entity. After associating the clusters with entity attributes corresponding to an entity, the routine 400 terminates.

The result of this association is that for each entity attribute, there is a cluster of elements that relate to the particular entity attribute of the particular entity. It should be appreciated, however, that the results of clustering the data sources is that an entity may have attributes (such as category based attributes) for which there is no corresponding cluster of data, or that the resulting cluster includes limited elements. Of course, there may be entity attributes for which there is a large volume of data. As should be appreciated, the elements within a cluster associated with individual entity attributes are not necessarily described in the same way. For example, with regard to the entity attribute question 212 of FIGS. 2B and 2C, “when is mitt romney's birthday,” those skilled in the art will appreciate that this question may be phrased in any number of ways, including “when was mitt born,” “what day is governor romney's birthday,” and the like. Not all of the search queries that are associated with an individual attribute will be formed in a linguistically correct manner. Thus, from all of the queries and content that correspond to a particular entity attribute for a particular entity, it is important to identify a linguistically correct question or, at least, the most linguistically correct question.

Returning again to block 310 of FIG. 3, a representative entity attribute question is selected for each attribute that will be presented to the user. For each of the selected attributes, a representative entity attribute question is selected on the basis of which question of the questions available in the cluster of elements, is most linguistically correct. Finding the most linguistically correct entity attribute question is discussed below in regard to FIG. 5. In regard to determining a representative entity attribute question, a representative entity attribute question may be identified prior to receiving a search query from a user, the representative entity attribute question may be identified in a just-in-time manner in which the question is identified the first time the entity attribute corresponding to a particular entity is requested (and then saved for later reference), or maybe determined each time the entity attribute is surfaced to a user.

At block 312, the selected attributes are optionally categorized according to the nature of the question that they answer. As already discussed in regard to FIGS. 2B and 2C, the “nature of the question” corresponds to the general information that each question might answer such as “what,” “when,” “where,” “how,” and the like. Categorizing the selected attributes according to the nature the question that they answer is an organizational feature that enables the user to more readily identify and locate entity attribute questions that are most interesting to a computer user.

At block 314, an entity pane, such as entity pane 206 of FIG. 2A is optionally generated. As with entity attribute questions, presenting an entity pane 206 that corresponds to the identified entity enables the search engine in conjunction with an entity component to provide focused, detailed information for the user such that the user does not need to navigate elsewhere, e.g., via a search result hyperlink, for information that is sought by the computer user. According to at least one embodiment of the disclosed subject matter, the entity attribute questions 210 are included as part of the entity pane 206.

At block 316, at least one search results page is generated. The generated search results page includes at least a portion of the obtained search results and the entity pane 206 that includes the entity attribute questions 210. In an alternative embodiment where the entity pane 206 is not included, the search results page is generated including a portion of the obtained search results and the entity attribute questions. In short, in at least one embodiment entity attribute questions 210 are included in a search results page irrespective of the presence of an entity pane 206.

After generating a search results page responsive to a computer user search query, at block 320, the search results page is returned to the computer user. Thereafter, the routine 300 terminates.

As mentioned above in regard to block 310, selecting a representative entity attribute question for each selected attribute, FIG. 5 is a flow diagram of an illustrative routine 500 for selecting a linguistically correct representative entity attribute question from a cluster of data associated with an entity attribute for a particular entity. Beginning at control block 502, a looping construct is begun to iterate through each element in the cluster associated with the entity attribute. Thus, for each element in the cluster, at block 504, the elements are scored for its grammatical, linguistic correctness by way of a language module. At block 506, after scoring each element in the cluster for grammatical, linguistic correctness, the element with the highest likelihood as being linguistically and grammatically correct is selected as the representative entity attribute question for the entity attribute. Thereafter, the routine 500 terminates.

As suggested above, a representative entity attribute question may be selected a priori to receiving a search query from a computer user, may be selected in a just-in-time fashion and then stored with the cluster, or maybe selected each time a representative entity attribute question for this particular entity attribute/entity pair is needed. Those skilled in the art will appreciate that there may be times that a representative entity attribute question should be dynamically determined, such as when the contents of the cluster corresponding to the attribute art in a constant state of transition.

Regarding the routines of FIGS. 3-5, it should be appreciated that while they are expressed with discrete steps, these steps should be viewed as being logical in nature and may or may not correspond to any actual, discrete steps. Nor should the order that these steps are presented be construed as the only order in which the various steps may be carried out in their respective routines. Further, those skilled in the art will appreciate that logical steps may be combined together or be comprised of multiple steps. Still further, while novel aspects of the disclosed subject matter are expressed in routines or methods, this functionality may also be embodied in computer-readable media. As those skilled in the art will appreciate, computer-readable media can host computer-executable instructions for later retrieval and execution. When executed on a computing device, the computer-executable instructions carry out various steps or methods. Examples of computer-readable media include, but are not limited to: optical storage media such as digital video discs (DVDs) and compact discs (CDs); magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this document, however, computer-readable media expressly excludes carrier waves and propagated signals.

Turning now to FIG. 6, FIG. 6 shows illustrative components of a search engine 110 configured to respond to a computer user's search query with search results and with entity attribute questions to 10 corresponding to attributes of unknown entity. As will be discussed below, the search engine 110 is configured with an entity component 616. However, as already discussed, this represents a non-limiting embodiment of the disclosed subject matter.

As shown in FIG. 6, the search engine 110 includes a processor 602 and a memory 604. As those skilled in the art will appreciate, the processor 602 executes instructions retrieved from the memory 604 in carrying out various aspects of the search engine service, including surfacing entity attribute questions corresponding to the selected attributes of unknown entity identified from a computer user's search query to the search engine.

The search engine 110 also includes a communications component 606 through which the search engine sends and receives communications over the network 108. For example, it is through the communication component 606 that the search engine 110 receives search queries from user on user computers, such as user computers 102-106, and by which the search engine returns results responsive to user's search queries. The search engine 110 further includes a search results retrieval component 608 and a search results page generator 610. Regarding the search results retrieval component 608, this logical component is responsible for retrieving, or obtaining, search results information relevant to a computer user's search query from a content index 612 associated with the search engine 110.

The search results page generator 610 generates one or more search results pages from the search results obtained by the search results retrieval component 608 and also including entity attribute questions of attributes corresponding to an identified entity of the user's search query. In one embodiment of the disclosed subject matter, the entity attribute questions are included within an entity pane 206 that includes information focused particularly on the identified entity. The entity attribute questions corresponding to an identified entity is drawn from an entity store 614.

Also illustrated is an entity component 616. The entity component is the component that (by way of illustration and not limitation) identifies entities from the search queries submitted by computer users; mines query logs and content sources, social network traffic, news feeds, and the like to identify entity attributes (as described above); identifies representative entity attribute questions; and classifies entity attributes according to the nature of the entity attribute. As shown in FIG. 6, the entity component is comprised of various sub-components that carry out these and other features, including the entity identification component 618 (that identifies the entity (or entities) of a search query and determines whether the entity is a known entity); the entity mining component 620 (that mines query logs and content sources, social network traffic, news feeds, and the like to identify entity attributes); the entity attribute selection component 622 (that identifies representative entity attribute questions from those entity attributes that are most important for a given entity); and an entity attribute question classifier 624 (that classifies the entity attribute questions according to the nature of the entity attribute represented by the question).

It should be appreciated, of course, that many of these components (both of the search engine 110 as well as the entity component 616) should be viewed as logical components for carrying out various functions of a suitably configured search engine 110 and/or entity component 616. These logical components may or may not correspond directly to actual components. Moreover, in an actual embodiment, these components may be combined together or broke up across multiple actual components.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to a search query from a user, the method comprising:
obtaining a plurality of search results responsive to a search query received from a computer user over a communication network;
determining that the search query corresponds to an entity for which corresponding entity information is stored in an entity store, wherein the entity information comprises a plurality of entity attributes;
selecting a subset of the entity attributes from the plurality of entity attributes corresponding to the entity and, for each selected entity attribute, identifying a representative entity attribute question;
generating a search results page responsive to the search query, the search results page including at least some of the identified search results, and further including the identified representative entity attribute questions; and
returning the search results page for presentation to the user.

2. The method of claim 1, wherein the representative entity attribute questions are linguistically correct.

3. The method of claim 2, wherein selecting a representative entity attribute question comprises:
clustering a plurality of search queries regarding the entity;
associating the clusters with a corresponding attribute of the entity; and
for each cluster:
analyzing the search queries of the cluster to determine the probability of each search query being formed linguistically correct; and
selecting the search query in the cluster with the highest probability of being formed linguistically correct as the representative entity attribute question for the associated attribute of the entity.

4. The method of claim 3 further comprising categorizing the representative entity attribute questions into a plurality of groups according to the nature of the answers of the representative entity attribute questions; and
wherein generating the search results page responsive to the search query comprises generating the search results page to include at least some of the identified search results and the identified representative entity attribute questions, wherein the identified representative entity attribute questions are grouped together according to their categorization on the search results page.

5. The method of claim 4, wherein the nature of the answers of representative entity attribute questions comprise any one of who, what, when, where, how, and why.

6. The method of claim 5, wherein generating the search results page responsive to the search query further comprises generating the search results page to include at least some of the identified search results and an entity pane, the entity pane including information corresponding to the entity and further including the identified representative entity attribute questions grouped together according to their categorization in the entity pane on the search results page.

7. The method of claim 1, wherein the identified representative entity attribute questions included in the generated search results page are user-actionable to provide the corresponding answers to the representative entity attribute questions.

8. The method of claim 1, wherein selecting the subset of the entity attributes from the plurality of entity attributes corresponding to the entity comprises selecting a subset of entity attributes that are of high importance to the entity.

9. A computer-readable medium bearing computer-executable instructions which, when executed on a computing system comprising at least a processor, carry out a method for responding to a search query from a user, the method comprising:
obtaining a plurality of search results response to a search query received from a computer user over a communication network;
determining that the search query corresponds to an entity for which corresponding entity information is stored in an entity store, wherein the entity information comprises a plurality of entity attributes;
selecting a subset of the entity attributes from the plurality of entity attributes corresponding to the entity and, for each selected entity attribute, identifying a representative entity attribute question;
categorizing the representative entity attribute questions into a plurality of groups according to the nature of the answers of the representative entity attribute questions;
generating a search results page responsive to the search query, the search results page including at least some of the identified search results, and further including the identified representative entity attribute questions, wherein the identified representative questions are grouped on the search results page according to their categorization; and
returning the search results page for presentation to the user.

10. The computer-readable medium of claim 9, wherein selecting a subset of the entity attributes from the plurality of entity attributes corresponding to the entity comprises:
clustering a plurality of search queries regarding the entity; and
associating each of the resulting clusters with a corresponding attribute of the entity.

11. The computer-readable medium of claim 10, wherein selecting a subset of the entity attributes from the plurality of entity attributes corresponding to the entity further comprises, for each cluster:
analyzing the queries of the cluster to determine the probability of each query being formed linguistically correct; and
selecting the query in the cluster with the highest probability of being formed linguistically correct as the representative entity attribute question for the associated attribute of the entity.

12. The computer-readable medium of claim 11, wherein the method further comprises:
categorizing the representative entity attribute questions into a plurality of groups according to the nature of the answers of the representative entity attribute questions; and
wherein generating the search results page responsive to the search query comprises generating the search results page to include at least some of the identified search results and the identified representative entity attribute questions, wherein the identified representative entity attribute questions are grouped together according to their categorization on the search results page.

13. The computer-readable medium of claim 12, wherein the nature of the answers of representative entity attribute questions comprise any one of who, what, when, where, how, and why.

14. The computer-readable medium of claim 13, wherein generating the search results page responsive to the search query further comprises generating the search results page to include at least some of the identified search results and an entity pane, the entity pane including information corresponding to the entity and further including the identified representative entity attribute questions grouped together according to their categorization in the entity pane on the search results page.

15. The computer-readable medium of claim 9, wherein selecting the subset of the entity attributes from the plurality of entity attributes corresponding to the entity comprises selecting a subset of entity attributes that are of high importance to the entity.

16. A computer system for responding to a search query, the computer system comprising a processor and a memory, wherein the processor executes instructions stored in the memory as part of or in conjunction with additional components to respond to a search query from a computer user, the additional components comprising:
a communication component by which the computer system receives the search query from the computer user and returns a generated search results page to the computer user over a network;
a search results retrieval component that obtains a plurality of search results from a content store responsive to the computer system receiving the search query from the computer user;
an entity store storing entity information for each of the plurality of entities, wherein the entity information for each entity comprises a plurality of entity attributes;
an entity component that identifies to which of a plurality of entities the received search query corresponds, and that selects a subset of entity attributes from the plurality of entity attributes stored in the entity store for the identified entity, and that further selects a representative entity attribute question for each of the entity attributes in the selected subset of entity attributes; and
a search results page generator that generates at least one search results page comprising a subset of the plurality of search results and further comprising the identified representative questions, and returns the at least one generated search results page to the computer user via the communication component.

17. The computer system of claim 16, wherein the entity component comprises an entity identification component that identifies whether and to which of a plurality of entities the received search query corresponds.

18. The computer system of claim 17, wherein the entity component further comprises an entity mining component that:
analyzes data sources to identify content related to various attributes of the entity;
clusters the data sources such that elements within a cluster a highly related to each other and elements between clusters have little to no relationship to each other; and
associates each cluster with an attribute of the entity in the entity store.

19. The computer system of claim 18, wherein the entity component further comprises an entity attribute selection component that identifies representative entity attribute questions from entity attributes that are most important for a given entity.

20. The computer system of claim 19, wherein the entity component further comprises an entity attribute question classifier that classifies the entity attribute questions according to the nature of the entity attribute represented by the question.
